(19) United States
(12) Patent Application Publication
(10) Pub. No.: US 2009/0086039 A1
(43) Pub. Date: Apr. 2, 2009

(54) Compound lens and camera comprising the same

(75) Inventors: Hisashi Goto, Tokyo (JP); Manabu Yoshii, Yokohama (JP); Keisuke Ichikawa, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignees: Olympus Imaging Corp., Shibuya-ku (JP); Olympus Corporation, Shibuya-ku (JP)

(21) Appl. No.: 11/904,410

(22) Filed: Sep. 27, 2007

(51) Int. Cl. H04N 5/228

(52) U.S. Cl. 348/208.11; 348/E05.031

(57) ABSTRACT

A compound lens on which a plastic lens is formed on a glass lens, having:
an annular step part which is formed on the end part of the optical functional surface, on which the plastic lens is formed, on the outer circumference side on the outside of the outermost diameter of the optical functional surface and which is formed for directly mounting on a resin-made lens tube frame; and a caulk-fix part, being formed, in a form of a chamfer, in the outer form part of the glass lens on the optical functional surface on the opposite side of the optical functional surface on which the plastic lens is formed, wherein an influence of a heat on the plastic lens is eliminated when fixing the glass lens onto the resin-made lens tube frame by means of thermal caulking.

### BACKGROUND OF THE INVENTION

1. Field of the Invention

The present invention relates to a compound lens featured with a resin layer on a glass lens and to a camera comprising the lens.

2. Description of the Related Art

A compound optical element such as a compound optical lens is formed by layering a resin layer having a lens function on the base optical functional surface of a glass lens, et cetera, thereby making the lens compact as a whole and improving the performance of an aberration correction (especially a chromatic aberration). The compound optical element possesses a superior optical performance unobtainable by a single optical lens. It is therefore given an important position in the fields such as a camera comprising a photo optical system, a microscope and a medical device including an endoscope, et cetera.

A known conventional technique as the kind of a compound optical element is one noted in a Laid-Open Japanese Patent Application Publication No. 2006-195052 for example. This technique equips a lens tube frame placed as a second group with a glass lens, equips the glass lens with a compound lens in the lens tube frame by way of a spacer and caulk-fixes the glass lens and compound lens together to the lens tube frame.

Also, a resin layer is formed in the concave surface part of the compound lens and a spacer for positioning a protrusion part generated by forming the resin layer is placed between the compound lens and glass lens.

A Laid-Open Japanese Patent Application Publication No. 2004-233697 has disclosed a technique of thermally caulking a lens frame in a state of a lens retention ring pressing a lens, thereby fixing the lens retention ring and lens onto the mirror frame. This configuration makes it possible to obtain a lens frame apparatus possessing an axis of a desirably high precision according to the reference patent document.

Also, a Laid-Open Japanese Patent Application Publication No. Sho 56-1006 has disclosed a technique of forming a groove on an outer circumference of a lens and thermally caulking a lens retention part of a resin-made lens tube corresponding to the groove from the outside. That is, the lens is fixed by inserting the resin part into the groove according to the reference patent document.

And a registered Japanese patent No. 2679784 has disclosed a technique of comprising a caulk part for fixing a lens to a lens tube by being equipped on one end of a lens tube and of comprising a cylindrical groove formed on the internal circumference surface opposite to the caulked part and outer circumference of the lens. It also makes the cylindrical groove absorb an amount of deformation caused by the caulking, thereby eliminating a gap generated between the caulked part and lens surface.

In the technique noted in the Laid-Open Japanese Patent Application Publication No. 2006-195052, however, the compound lens is fixed onto the lens tube frame together with another lens by way of the spacer, and therefore the mounting precision of the compound lens per se is not good. That is, the positioning accuracy in relation to the lens tube frame cannot be secured when fixing it by means of caulking. The optical axis can be shifted when caulking it because the load applied to the glass lens at the time of caulking is not uniform. The resin layer of a compound lens is usually nonspherical, thus requiring a high precision.

The technique noted in the Laid-Open Japanese Patent Application Publication No. 2004-233697 is for obtaining a lens frame apparatus possessing a high axis precision by applying a thermal caulking, requiring a lens retention ring for pressing the lens instead of the lens frame pressing the lens directly. This therefore is faced with the problem of an increased number of components and a higher production cost.

The technique noted in the Laid-Open Japanese Patent Application Publication No. Sho 56-1006 is not targeted for a compound lens and faced with a difficulty in forming a grove of a high precision centering. Therefore, there is a risk of the lens being fixed in a state of being eccentric. Moreover, the fact of the groove supporting a force in the optical axis direction makes it difficult to secure a large retention force.

Meanwhile, the technique noted in the registered Japanese patent No. 2679784 supports a bottom surface crossing in the direction practically perpendicular to the optical axis direction of a lens and a side surface parallel with the optical axis direction by using a lens tube. Therefore, a high precision centering is difficult to achieve because a face feature part of the optical functional surface of the lens is too difficult to be supported by the lens tube in a contact manner.

### SUMMARY OF THE INVENTION

A compound lens according to the present invention is one on which a plastic lens is formed on an optical functional surface of a glass lens, comprising: an annular step part which is formed on the end part of the optical functional surface, on which the plastic lens is formed, on the outer circumference side on the outside of the outermost diameter of the optical functional surface and which is formed for directly mounting on a resin-made lens tube frame; and a caulk-fix part, being formed, in a form of a chamfer, in the outer form part of the glass lens on the optical functional surface on the opposite side of the optical functional surface on which the plastic lens is formed, wherein an influence of a heat on the plastic is eliminated when fixing the glass lens onto the resin-made lens tube frame by means of a thermal caulking after placing the glass lens on the resin-made lens tube frame by way of the step part so as to match the optical axis.

A camera according to the present invention is one, comprising: a lens tube which comprises plural lens frames and which is mounted onto a camera main body; an imaging element for converting an object light passing through the lens tube into an electric signal; and a compound lens placed closest to an object side of a lens frame positioned closest to the object side when individual lens frames constituting the lens tube are placed in the respective initial positions for enabling photographing, wherein the compound lens is a lens on which a plastic lens part is formed on an optical functional surface of a glass lens and the aforementioned plastic lens is placed in a manner to be positioned on the imaging element side.

### BRIEF DESCRIPTION OF THE DRAWINGS

The present invention will be more apparent from the following detailed description when the accompanying drawings are referred to.

FIG. 1 is a cross-section diagram of a compound lens according to the present embodiment;

FIG. 2 is a cross-section diagram of the state of supporting a compound lens onto a lens tube frame;

FIG. 3 is a cross-section diagram of a digital camera in the state of a lens tube having been retracted;

FIG. 4 is cross-section diagram of a digital camera in the state of a lens tube having been extended to a wide angle position; and

FIG. 5 is a cross-section diagram of a digital camera in the state of a lens tube having been extended to a zooming position in a telephoto position.

### DETAILED DESCRIPTION OF THE PREFERRED EMBODIMENT(S)

The following is a description of the preferred embodiment of the present invention by referring to the accompanying drawings.

### First Embodiment

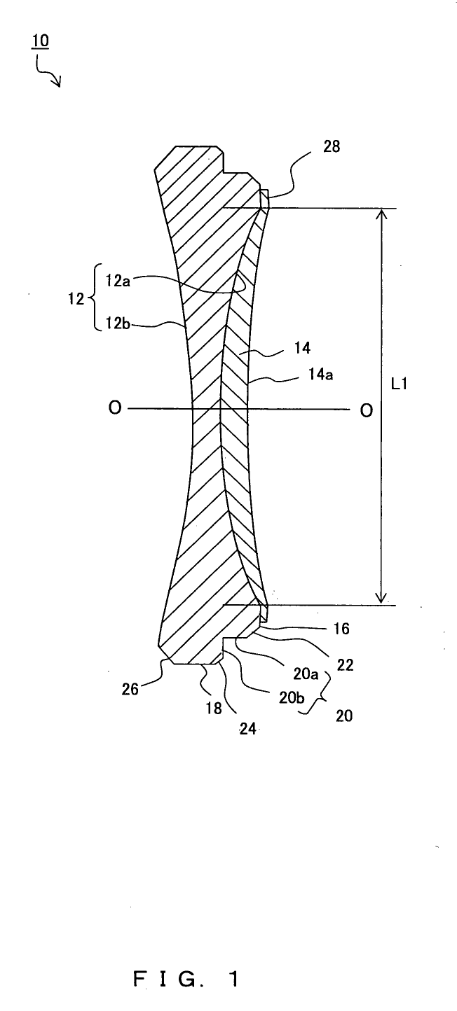

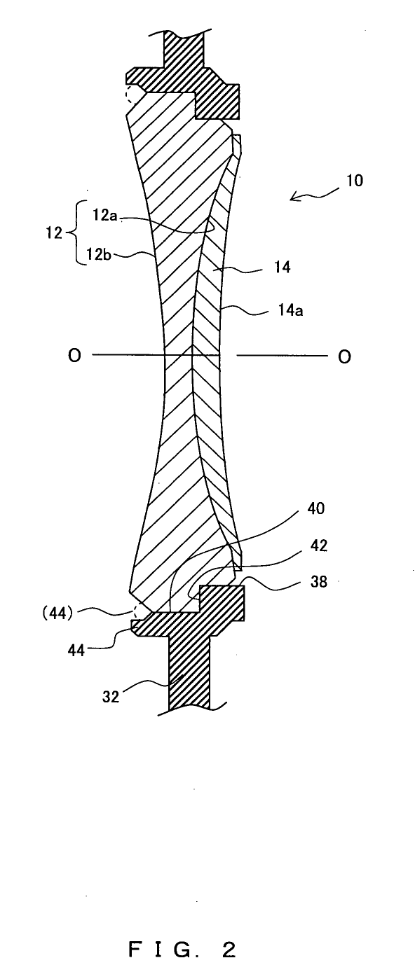

FIG. 1 is a cross-section diagram of a compound lens according to the present embodiment; and FIG. 2 is a cross-section diagram of the state of mounting the compound lens onto a lens tube frame.

The compound lens 10 comprises a glass lens 12, which possesses a first optical functional surface 12a of a concave form and a second optical functional surface 12b of a concave form, and a plastic lens 14 formed on the first optical functional surface 12a of the glass lens 12. The surface (i.e., an optical functional surface 14a) of the plastic lens 14 on the opposite side of the adhesion surface to the glass lens 12 is featured with a nonspherical meniscus formation for instance.

The glass lens 12 is featured with an annular step part 20 which is formed on the end part of the optical functional surface 12a, on which the plastic lens 14 is formed, on the outer circumference side on the outside of the outermost diameter L1 of the optical functional surface 12a. The step part 20 is formed for directly mounting the glass lens 12 on a lens tube frame 32 described later (refer to FIG. 2). The lens tube frame 32 is made from a thermoplastic resin such as polycarbonate.

Also, the step part 20 comprises an inner circumferential surface 20a extending in the optical axis (O-O) direction and a contact surface 20b which is perpendicular to the aforementioned inner circumferential surface 20a and which is directly in contact with the lens tube frame 32.

The present embodiment is configured in a manner that at least the contact surface 20b, among the inner circumferential surface 20a and contact surface 20b of the step part 20, is processed to be a high precision, flat and smooth surface in the direction perpendicular to the optical axis. The contact surface 20b constitutes a mounting surface in contact with, and supported by, the lens tube frame 32.

The glass lens 12 is equipped with a protrusion part 16, in which a resin is protruded when forming the present plastic lens 14, between the annular step part 20 and a first optical functional surface 12a on which the plastic lens 14 is formed.

A chamfered part 22 is formed in the part where the protrusion part 16 merges with the inner circumferential surface 20a. Likewise, a small chamfered part 24 is formed in the region between the contact surface 20b and the lens outer form part 18. These chamfered parts 22 and 24 eliminate an occurrence of a protrusion or burr on the inner circumferential surface 20a of the step part 20 or the edge of the contact surface 20b. Therefore, when the compound lens 10 is mounted, at least the contact surface 20b of the step part 20 can be placed in close contact with a support surface 42 of the lens tube frame 32.

The glass lens 12 is further featured with a caulk-fix part 26 in the form of a chamfering in the lens outer form part 18 of a second optical functional part 12b on the opposite side of the first optical functional part 12a on which the plastic lens 14 is formed. The caulk-fix part 26 is used for fixing the glass lens 12 onto the resin-made lens tube frame by a thermal caulking.

The present embodiment is configured to form the caulk-fix part 26 at an inclined angle of practically 45° in relation to the optical axis direction. The inclination angle, however, is arbitrary provided that a process required for fixing the glass lens 12 is carried out for instance.

Meanwhile, the plastic lens 14 possesses a circular protrusion part 28 extending further away from the outer circumference side than the optical functional surface 14a of the plastic lens 14. The protrusion part 28 is inevitably generated when the plastic lens 14 is formed on the optical functional surface 12a of the glass lens 12. That is, the protrusion part 28 is generated attributably by a difficulty of managing a volume of a resin volume constituting the plastic lens 14 and is formed by a surplus portion of the melted resin protruding.

The protrusion part 28 of the plastic lens 14 is positioned in the protrusion part 16 between the annular step part 20 and the first optical functional part 12a of the glass lens 12. The protrusion part 16 of the glass lens 12 regulates the protrusion part 28 of the plastic lens 14 so as not to protrude to the outside in the radial direction beyond the inner circumferential surface 20a of the step part 20.

The reason for this is that the protrusion part 28, if it protrudes to the outside of the inner circumferential surface 20a of the step part 20, interferes with the lens tube frame 32, making it difficult to achieve a high precision positioning.

FIG. 2 is a cross-section diagram of the state of supporting the compound lens 10 onto the lens tube frame 32.

The lens tube frame 32 comprises an opening 38 formed at the center, and a lens accommodation hole 40 formed on the outer diameter side by way of a step. The lens accommodation hole 40 is formed concentric with the optical axis O-O of the compound lens 10. The lens accommodation hole 40 is formed in a diameter and height (i.e., a length) capable of accommodating the lens outer form 18 of the compound lens 10. Equipped between the lens accommodation hole 40 and opening 38 is a flat and smooth support surface 42 which is processed highly precisely in a direction perpendicular to the optical axis O-O.

Furthermore, a caulk wall 44, as caulk fix part, which is larger in diameter than the lens accommodation hole 40, is formed protrusively on one end (i.e., the left end of FIG. 2) of the lens accommodation hole 40 in the axial direction. Note that a radial corner is formed between the lens accommodation hole 40 and caulk wall 44.

Then, in order to fix the compound lens 10 onto the lens tube frame 32, the present compound lens 10 is inserted into the opening 38 and lens accommodation hole 40 of the lens tube frame 32. In this event, the insertion is performed in a manner that the optical axis O-O of the compound lens 10 is aligned with the center axis of the lens tube frame 32. Since the support surface 42 of the lens tube frame 32 is processed to be flat and smooth, the placement is achieved with the contact surface 20b of the glass lens 12 being closely contact with the support surface 42.

The above process is followed by thermally caulking the caulk wall 44 of the lens tube frame 32 onto the caulk-fix part 26 of the glass lens 12. In this case, the resin-made caulk wall 44 is softened by using a thermal caulking tool, in which event a prevention of a thermal influence on the plastic lens 14 is taken into consideration for the configuration.

That is, referring to FIG. 2, the plastic lens 14 is formed on the first optical functional surface 12a of the glass lens 12, while the caulk-fix part 26 is formed on the lens outer form 18 on the second optical functional surface 12b on the other side. As such, the plastic lens 14 and caulk-fix part 26 are positioned on the opposite side of the glass lens 12.

Therefore, even if a heat is applied to the caulk-fix part 26 in the event of the thermal caulking, an influence of the heat on the plastic lens 14 is small because the thermal conductivity of the glass lens is usually considered to be small.

The present embodiment comprises the annular step part 20 formed on the end part of the outer circumferential side of the glass lens 12, and the caulk-fix part 26 formed on the outer diameter part of the second optical functional surface 12b of the glass lens 12 on the opposite side of the surface on which the plastic lens 14 is formed, thereby avoiding an influence of a heat on the plastic lens 14 in the event of thermally caulking the compound lens 10 following placing it in the lens tube frame 32 by way of the step part 20 so as to align the optical axis.

It is also configured to fix the compound lens 10 onto the lens tube frame 32 by means of a thermal caulking, not requiring a screw or adhesive, thus enabling a reduction of the number of components.

Also configured is that the step part 20 formed on the glass lens has the inner circumferential surface 20a extending in the optical axis direction, and the contact surface 20b which is perpendicular to the inner circumferential surface 20a and which is directly in contact with the lens tube frame 32, thereby enabling a close contact between the compound lens 10 and lens tube frame 32 by using the contact surface 20b and a high precision fixing in the state of aligning the optical axis.

### Second Embodiment

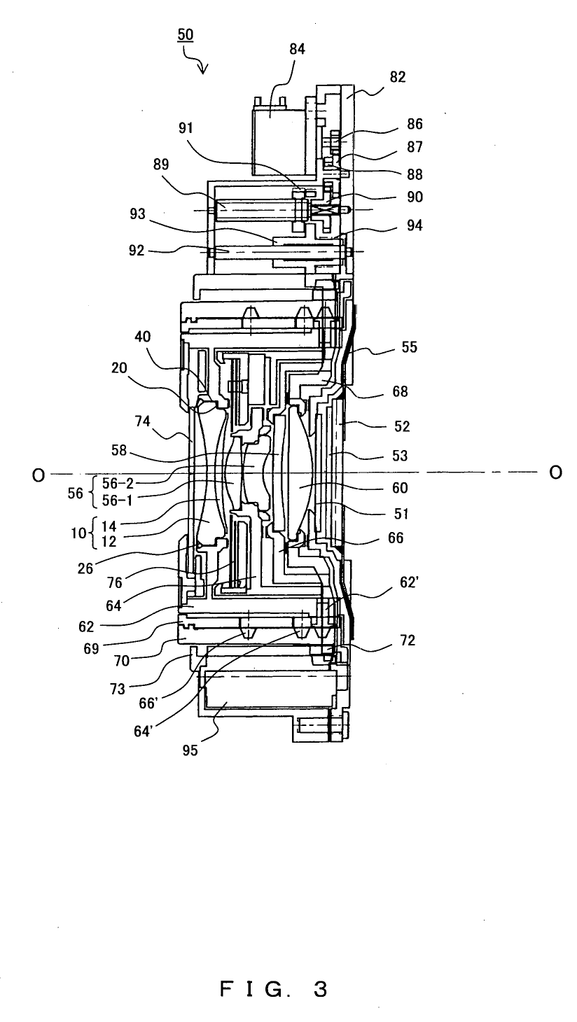

FIGS. 3 through 5 exemplify a digital camera 50 applying the compound lens 10 to the optical system.

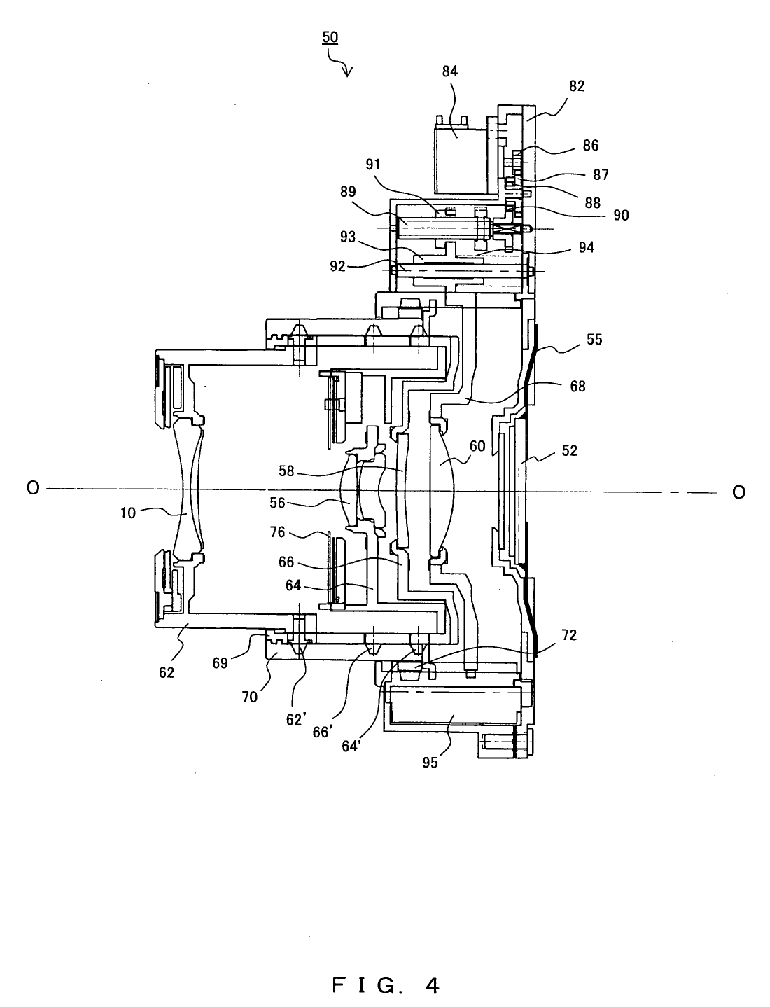

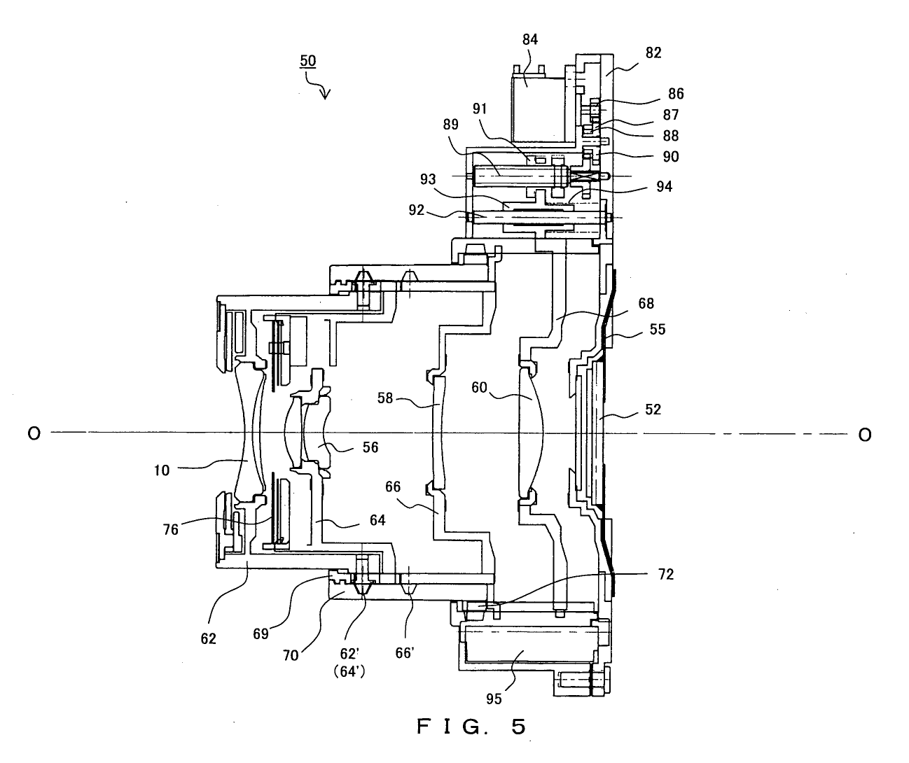

FIG. 3 is a cross-section diagram of a digital camera in the state of a lens tube having been retracted; FIG. 4 is cross-section diagram in the state of the lens tube having been extended to a wide angle position from the retracted position; and FIG. 5 is a cross-section diagram in the state of the lens tube having been extended to a zooming position in a telephoto position.

Next is a description of a configuration of a camera according to the present embodiment by referring to FIG. 3.

The camera main body is equipped with a drive motor (not shown in a drawing herein) (to be noted as “Z motor” hereinafter) for moving a lens tube (i.e., a first lens frame 62, a second lens frame 64 and a third lens frame 66) described later. The Z motor plays the role of moving the lens tube (i.e., the first lens frame 62, second lens frame 64 and third lens frame 66) from the retracted state to a wide angle position that is a photography initial position. The Z motor further plays the role of moving the lens tube (i.e., the first lens frame 62, second lens frame 64 and third lens frame 66) from the wide angle position to a telephoto state based on an output of a zoom switch.

A zoom gear (noted as “Z gear” hereinafter) 95 is a gear receiving a drive force from a Z motor (not shown in a drawing herein). The Z gear 95 has the length equivalent to the movement distance of each lens tube and is placed in parallel with the optical axis.

The Z gear 95 is meshed with a gear 72 integrally fixed to a cam cylinder 70. The gear 72 is one helicoid-meshing with the Z gear 95 so that the gear 72 is moved in the optical direction while rotating in association with the rotation of the Z gear 95. By this, a rotation of the gear 95 moves, in the optical direction, the cam cylinder 70 integrally fixed to the gear 72.

The cam cylinder 70 is equipped with cam grooves (not shown in a drawing herein) respectively engaging with cam followers 62′, 64′ and 66′ which are respectively equipped on the first lens frame 62, second lens frame 64 and third lens frame 66 constituting the lens tube.

A base plate 82 is equipped with a stationary cylinder 73. The inside of the stationary cylinder 73 is equipped with a guide cylinder 69 for securing the movements of the cam followers 62′, 64′ and 66′ in the optical axis direction. The guide cylinder 69 is moved along with the cam cylinder 70 in the optical axis direction.

The first lens frame 62, on which the above described compound lens (noted as “first lens” hereinafter) 10 is fixed, is placed in the inside of the guide cylinder 69. The first lens frame 62 is equipped with the cam follower 62′ following along a cam groove (not shown in a drawing herein) which is equipped on the cam cylinder 70.

The second lens frame 64, on which the second lens 56 constituted by two lenses (i.e., 56-1 and 56-2) is fixed, is placed on the inside of the first lens frame 62. The second lens frame 64 is equipped with the cam follower 64′ following along a cam groove (not shown in a drawing herein) equipped on the cam cylinder 70. The cam follower 64′ is equipped by piercing the first lens frame 62 so as not to interfere therewith.

On the inside of the second lens frame 64, is placed the third lens frame 66 on which the third lens 58 is fixed. The third lens frame 66 is equipped with the cam follower 66′ following along a cam groove (not shown in a drawing herein) equipped on the cam cylinder 70. The cam follower 66′ is also equipped in a manner to not interfere with the first lens frame 62.

On the inside of the third lens frame 66, is placed the fourth lens frame 68 on which the fourth lens 60 is fixed. The fourth lens frame 68 is moved by the drive force from an auto focus (note as “AF” hereinafter) motor 84. That is, the fourth lens frame 68 is automatically moved in a manner to focus in a set-up zooming state within the photographable state.

A low pass filter 51, a glass plate and an imaging element 52 such as CCD or the like are placed on the imaging side of the fourth lens 60 in the optical axis direction. A flexible board 55 is connected to the imaging element 52 which is for converting an object light transmitting through the lens tube into an electric signal.

A barrier 74 for protecting the first lens 10 is placed on the object side of the present first lens 10. An aperture mechanism 76 is equipped on the object side of the second lens 56. The aperture mechanism 76 functions as a lens shutter doubling as aperture.

The present embodiment is configured to place the first lens 10 on the closest side to an object of the first lens frame 62 which is positioned closest to the object.

That is, the plastic lens 14 is usually more susceptible to a thermal influence than the glass lens 12. Especially, if the plastic lens 14 is formed on the glass lens 12 as the first lens 10 according to the present embodiment, a deformation of the plastic lens 14 is suppressed by the glass lens 12. For this reason, an internal stress (i.e., a thermal stress) due to a heat is generated in the plastic lens 14. Therefore, the first lens 10 including the plastic lens 14 has been placed as far away from the heat source as possible.

The first lens 10 is a lens featured with the plastic lens 14 on the first optical functional surface 12a of the glass lens 12 as described above, in which the plastic lens 14 is placed so as to be positioned on the side of the imaging element 52.

That is, the plastic lens 14 is on the inner side of the glass lens 12 (i.e., away from the object side). Because the plastic lens 14 is soft, it is susceptible to an environmental condition such as contamination as compared to the glass lens 12. Accordingly, the plastic lens 14 is protected from direct contact with the outside air by placing it in the inner side of the glass lens 12. This prevents the optical functional surface of the plastic lens 14 from being contaminated with dust or dirt.

Also, the first lens 10 is positioned closest to the object side of the first lens frame 62 which is positioned closest to the object side. This configuration prevents the plastic lens 14 from being influenced by the imaging element 52 which constitutes a high heat source.

The imaging element 52 becomes heated up (e.g., 50° C. to 100° C.) due to a Joule heat at the time of photographing. There is no risk of plastic lens 14 being softened by a heat because it is placed in the farthest position from the heat source. This configuration eliminates a possibility of an optical performance of the resin lens being changed by a heat.

The first lens frame 62 on which the first lens 10 is mounted is a resin-made lens tube frame. The step part 20 is formed on the end part on the outer circumferential side which is larger than the maximum outer diameter L1 of the first optical functional surface 12a as described above. The step part 20 is formed in an annular form for direct mounted onto the first lens frame 62. The step part 20 is inserted into the lens accommodation hole 40 formed on the first lens frame 62 and fixed thereto.

That is, the caulk-fix part 26 is formed, in a chamfer form, on the outer diameter part on the side of the second optical functional surface 12b which is on the opposite side of the first optical functional surface 12a of the glass lens 12 on which the plastic lens 14 is formed. The caulk-fix part 26 is fixed onto the first lens frame 62 by means of thermal caulking.

In the event of the fixing, the step part 20 of the first lens 10 is inserted into the lens accommodation hole 40 of the first lens frame 62 in a manner to align the optical axis. In this state, the caulk wall (not shown in a drawing herein) formed on the object side of the first lens frame 62 is softened by heating. As such, the first lens 10 is directly fixed onto the first lens frame 62 by means of the thermal caulking using the caulk-fix part 26.

Also in this event, the caulk-fix part 26 is formed on the outer form part of the optical functional surface 12b on the opposite side of the optical functional surface 12a of the glass lens 12 on which the plastic lens 14, and therefore the protrusion part 28 (refer to FIG. 1) of the plastic lens 14 is never softened by the heat at the time of the caulking. Furthermore, the fixed first lens 10 is placed farthest from the imaging element 52 which heats up at the time of photographing, and therefore the optical performance of the plastic lens 14 is also never changed by the heat.

The next is a description on driving the fourth lens frame 68.

The fourth lens frame 68 is driven to a focusing position based on a value measured by a distance measurement apparatus (not shown in a drawing herein). In this event, an image of the object is imaged on the imaging element 52, in which event the imaging is photo-electrically converted into an image signal, followed by being stored in memory and/or displayed in a monitor. The following is a description of a configuration for carrying out the focusing operation.

In order to generate a drive force for an AF, the second gear 87 is meshed with the gear 86 receiving the drive force from the AF motor 84. The second gear 87 is meshed with the fourth gear 90 fixed onto the screw shaft 89 by way of the third gear 88 concentrically placed with the second gear 87. A nut 91 is screwed onto the screw shaft 89 with the nut 91 being restrained against a rotation around the axis.

An operation shaft 92 is equipped next to, and parallel with, the screw shaft 89. An operation member 93 is fitted onto the operation shaft 92 so as to allow a free axial movement of the former. The operation member 93 is continuously biased along the axial direction toward the object side by means of a (compression) spring 94. The operation member 93 is connected to the fourth lens group 60, enabling a linked movement therewith, by way of the fourth lens frame 68.

The operation member 93 engages a nut 91 screwed onto the screw shaft 89 so as to regulate a movement of the present operation member 93 toward the object side.

Next is a description of an operation starting from the retraction position shown in FIG. 3 to the lens tube moving to a wide angle position shown in FIG. 4.

When the power (not shown in a drawing herein) is turned on, the Z motor (not shown in a drawing herein) is driven and the drive force is transmitted to the Z gear 95.

Then, the rotation of the Z gear 95 rotates the gear 72 in helicoid mesh with the Z gear 95. Then the cam cylinder 70 integrally fixed with the gear 72 is moved, while rotating, in the optical axis direction. This action rotates a plurality of cam grooves (not shown in a drawing herein) which are formed on the cam cylinder 70.

Then, the cam followers 62′, 64′ and 66′ inserted into the cam grooves move in the optical axis direction (toward the object side). This is how the first lens frame 62, second lens frame 64 and third lens frame 66 which are respectively fixed onto the cam followers 62′, 64′ and 66′ are extended in the optical axis direction (toward the object side).

By this, the first lens 10, second lens 56 and third lens 58 respectively fixed onto the first lens frame 62, second lens frame 64 and third lens frame 66 are extended in the optical axis direction (toward the object side).

Meanwhile, at the same time of the drive control for the Z motor, the AF motor 84 is controlled. The rotation of the AF motor 84 rotates the second gear 87 meshing with the first gear 86, the third gear 88 meshing with the second gear 87, the fourth gear 90 meshing with the third gear 88 in sequence. This rotates the screw shaft 89 and accordingly moves the nut 91 in the optical axis direction. Associated with the movement of the nut 91, the operation member 93 in the state of being biased by the spring 94 moves in the same direction. The movement of the operation member 93 moves the fourth lens 60 to a prescribed position in the optical axis direction (toward the object side).

In this event, a pressing of a release button (not shown in a drawing herein) makes distance measurement means (not shown in a drawing herein) calculate the distance to the object and moves the fourth lens 60 in the optical axis direction, and performs automatic focusing.

Furthermore, an operation of the zoom switch in the state of the lens tube having moved to the wide angle position shown in FIG. 4 prompts the lens tube to move to a zoom position in the telephoto state shown in FIG. 5.

That is, the operation of the zoom switch drives the Z motor (not shown in a drawing herein) in the same manner as described above and the drive force is transmitted to the Z gear 95 as shown in FIG. 5. The rotation of the Z gear 95 rotates the gear 72. Then the cam cylinder 70 equipped with the gear 72 rotates, and the first lens frame 62 moves.

Meanwhile, the cam grooves (not shown in a drawing herein) respectively engaged with the cam follower 64′ equipped in the second lens frame 64 and with the cam follower 66′ equipped in the third lens frame 66 are formed by inclining at a prescribed angle in relation to the optical axis, and therefore they are extended toward the object direction along the inclination angle. In this event, the cam groove (not shown in a drawing herein) engaged with the cam follower 64′ of the second lens frame 64 is formed in a large inclination angle relative to the optical axis direction, it is greatly extended to the object side.

In the zoom position, the focal distance of the optical system constituted by the first lens 10, second lens 56, third lens 58 and fourth lens 60 is set to be long. Therefore, the second lens 56 fixed onto the second lens frame 64 is especially in the state of being close toward the object side in the optical axis direction. In the zoom position, an object positioned a far distance from the optical system can be imaged large.

That is, the fourth lens frame 68 is driven by the AF motor 84 in association with the movements of the first lens frame 62, second lens frame 64 and third lens frame 66 which are driven by the Z motor (not shown in a drawing herein), thereby a focusing being performed.

As described above, the present embodiment is configured to place the first lens 10 on the end part of the first lens frame 62 which is the closest to the object among the first lens frame 62, second lens frame 64, third lens frame 66 and fourth lens frame 68, thereby avoiding an influence, on the plastic lens 14 formed on the first lens 10, of the imaging element 52 heating up at the time of photographing. As such, damage of the plastic lens 14 due to heat can be prevented.

Meanwhile, the plastic lens 14 formed on the first lens 10 is susceptible to contamination as compared to the glass lens 12; the placement of the plastic lens 14 on the imaging side on the inner side of the glass lens 12, however, makes it possible to obtain a camera of a good durability uninfluenced by environmental conditions.

The present embodiment is further configured in a manner that the first lens 10 comprises the step part 20 for mounting it directly onto the first lens frame 62 and the caulk-fix part 26 formed on the outer form part on the optical functional surface 12b on the opposite side of the optical functional surface 12a of the glass lens 12 on which the plastic lens 14 is formed, thereby enabling a high precision mounting of the first lens 10 onto the first lens frame 62 without being influenced by being heated by thermal caulking at a time of caulk-fixing.

1. A compound lens having a glass lens and a plastic lens formed on a first optical functional surface of the glass lens, comprising:
an annular step part formed on an end part of the optical functional surface, which is outside of an outermost diameter of the first optical functional surface and configured for directly mounting on a lens tube frame formed of a resin; and
a caulk-fix part, being configured to form a chamfer, and being located at an outer part of the glass lens and along a second optical functional surface located on an opposite side of the first optical functional surface on which the plastic lens is formed, wherein
an influence of heat on the plastic lens is eliminated when fixing the glass lens onto the resin-made lens tube frame by thermal caulking after placing the step part of the glass lens on the resin-made lens tube frame to align an optical axis of the tube frame to be coincident with an optical axis of the compound lens.

2. The compound lens according to claim 1, wherein
the step part comprises an inner circumferential surface extending in an optical axis direction and a contact surface perpendicular to the inner circumferential surface and directly in contact with the resin-made lens tube frame.

3. The compound lens according to claim 1, wherein
the glass lens has a protrusion part, arranged between the annular step part and the first optical functional surface and configured to receive resin protruded in an outward radial direction along the protrusion part when the plastic lens is formed on the glass lens.

4. A camera, comprising:
a lens tube which comprises plural lens frames and which is mounted onto a camera main body;
an imaging element for converting an object light passing through the lens tube into an electric signal; and
a compound lens placed closest to an object side of one of said lens frames which is positioned closest to an object side when the lens frames of the lens tube are placed in initial positions for enabling photographing, wherein
the compound lens is a glass lens having a plastic lens part formed on an optical functional surface of the glass lens and the compound lens is placed in said one of said lens frames to be positioned on an imaging element side.

5. The camera according to claim 4, wherein
said one of said lens frames in which the compound lens is placed is a plastic lens tube frame formed of a resin, wherein the compound lens further comprises
an annular step part formed on an end part of the optical functional surface, which is outside of an outermost diameter of the optical functional surface and configured for directly mounting on a lens tube frame formed of a resin; and
a caulk-fix part, being configured to form a chamfer, and being located at an outer part of the glass lens and along a second optical functional surface located on an opposite side of the first mentioned optical functional surface on which the plastic lens is formed.
